(19) United States
(12) Patent Application Publication
(10) Pub. No.: US 2010/0231561 A1
(43) Pub. Date: Sep. 16, 2010

(54) LIQUID CRYSTAL DISPLAY DEVICE

(75) Inventor: Katsumi MATSUMOTO, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/702,987

(22) Filed: Feb. 9, 2010

(30) Foreign Application Priority Data
Mar. 12, 2009 (JP) 2009-058905

(51) Int. Cl. G09G 3/36; G02F 1/1368

(52) U.S. Cl. 345/206; 349/46

(57) ABSTRACT

A liquid crystal display device includes: a liquid crystal display panel having a pair of substrates which is arranged to face each other in an opposed manner with liquid crystal sandwiched therebetween; and a backlight arranged on a one-side surface of the liquid crystal display panel. Thin film transistors are formed on a liquid-crystal-side surface of the substrate on a backlight side. In such a liquid crystal display device, the thin film transistor is constituted of a gate electrode, a gate insulation film which is formed so as to cover the gate electrode, a semiconductor layer which is formed on an upper surface of the gate insulation film, and a pair of electrodes which is arranged to face each other in an opposed manner on an upper surface of the semiconductor layer from the substrate side as viewed in a plan view. The semiconductor layer is formed of a stacked body consisting of a microcrystalline semiconductor layer and an amorphous semiconductor layer from the substrate side, and the semiconductor layer is formed in an island shape within a region where the gate electrode is formed as viewed in a plan view. Each one of the pair of electrodes is formed such that, as viewed in a plan view, sides of the each one electrode excluding a side of the each one electrode which faces the other electrode project outwardly from the semiconductor layer, and a portion of the each one electrode which projects outwardly from the semiconductor layer overlaps with the gate electrode at least on the periphery of the semiconductor layer.

The present application claims priority from Japanese application JP 2009-058905 filed on Mar. 12, 2009, the content of which is hereby incorporated by reference into this application.

### BACKGROUND OF THE INVENTION

1. Field of the Invention

The present invention relates to a liquid crystal display device, and more particularly to a liquid crystal display device which includes a backlight.

2. Description of the Related Art

A liquid crystal display panel is configured to control light transmission quantities of respective pixels independently and hence, the liquid crystal display panel is usually provided with a backlight on a back surface thereof.

Further, with respect to such a liquid crystal display panel, there has been used a liquid crystal display panel in which respective pixels are driven by so-called active matrix driving. In this case, each pixel includes at least a thin film transistor. The thin film transistor is a so-called MIS (Metal Insulator Semiconductor) transistor, and functions as a switching element for pixel selection.

The thin film transistor may adopt the so-called bottom gate structure. In the bottom gate structure, on a liquid-crystal-side surface of a backlight-side substrate out of a pair of substrates which is arranged to face each other in an opposed manner with liquid crystal sandwiched therebetween, a gate electrode is arranged below a semiconductor layer.

In the thin film transistor having such a constitution, it is often the case that a semiconductor layer of the thin film transistor is formed of, for example, an amorphous semiconductor layer (for example, made of amorphous silicon). However, as disclosed in JP-A-2005-167051 (patent document 1), there has been also known a thin film transistor where a semiconductor layer is formed of a sequentially stacked body consisting of a polycrystalline semiconductor layer (for example, made of polysilicon) and an amorphous semiconductor layer from a gate electrode side. The thin film transistor having such a constitution has an advantageous effect that a so-called S value (swing factor) which is one of initial characteristics can be suppressed to a small value, and an advantageous effect that a change of a threshold voltage with time can be suppressed to a small value.

Further, recently, there has been also known a thin film transistor which uses a microcrystalline semiconductor layer (for example, made of microcrystalline silicon) in place of a polycrystalline semiconductor layer in the constitution shown in patent document 1. Although mobility of carriers in the microcrystalline semiconductor layer is not high compared to the mobility of carriers in the polycrystalline semiconductor layer, the microcrystalline semiconductor layer can be manufactured more simply than the polycrystalline semiconductor layer. Accordingly, the microcrystalline semiconductor layer has been attracting attentions recently.

FIG. 7A and FIG. 7B show a thin film transistor TFT having the bottom gate structure where a semiconductor layer is formed of a sequentially stacked body consisting of a microcrystalline semiconductor layer and an amorphous semiconductor layer. FIG. 7A is a plan view of the thin film transistor TFT, and FIG. 7B is a cross-sectional view taken along a line b-b in FIG. 7A. To briefly explain the thin film transistor TFT, gate electrodes GT are formed on an upper surface of a substrate SUB1, and an insulation film (gate insulation film) GI is formed so as to cover the gate electrodes GT. Semiconductor layers SCL are formed on an upper surface of the insulation film GI in a state that the semiconductor layer SCL straddles the gate electrode GT. The semiconductor layer SCL is formed of a sequentially stacked body consisting of a microcrystalline semiconductor layer MS (for example, made of microcrystalline silicon) and an amorphous semiconductor layer AS (for example, made of amorphous silicon). On an upper surface of the semiconductor layer SCL, a drain electrode DT and a source electrode ST which are arranged to face each other are formed. Each electrode projects from the semiconductor layer SCL at an edge portion thereof on a side opposite to a side thereof which faces one electrode, and extends on the insulation film GI. Below the drain electrode DT and the source electrode ST, an amorphous semiconductor layer doped with high-concentration impurity is formed as a contact layer CN.

FIG. 7A and FIG. 7B are views prepared corresponding to FIG. 1A and FIG. 1B which illustrate a portion of a liquid crystal display device according to an embodiment of the present invention and hence, the explanation of the constitution shown in FIG. 7A and FIG. 7B is limited to the above-mentioned description. Other details of the constitution shown in FIG. 7A and FIG. 7B are understood from the explanation of the constitution shown in FIG. 1.

### SUMMARY OF THE INVENTION

However, in the thin film transistor shown in FIG. 7A and FIG. 7B, light emitted from a backlight (indicated by an arrow in the drawing) is radiated to the semiconductor layer SCL which projects from the gate electrode GT, and the microcrystalline semiconductor layer MS is formed on a gate-electrode-GT side of the semiconductor layer SCL and hence, there arises a drawback that a photo leak occurs.

When the photo leak occurs, a signal voltage written in the pixel electrode for driving liquid crystal generates an OFF current due to photoelectric conversion caused by light emitted from the backlight. FIG. 8 is a graph in which a generation amount of an OFF current of the thin film transistor shown in FIG. 7A and FIG. 7B is indicated by a curve α. Brightness (cd/m2) of light emitted from the backlight is taken on an axis of abscissas and the OFF current (pA) is taken on an axis of ordinates in the graph. In FIG. 8, for a comparison purpose, a generation amount of an OFF current of a thin film transistor which forms a semiconductor layer thereof using only amorphous silicon and has the same constitution with respect to other constitutional parts is indicated by a curve β. It is understood from this graph that a generation amount of the OFF current of the thin film transistor shown in FIG. 7A and FIG. 7B is extremely large. It is considered that this photo leak occurs due to a phenomenon that photoelectrons and holes generated in the amorphous semiconductor layer are efficiently separated from each other in the microcrystalline semiconductor layer due to light emitted from the backlight.

Accordingly, it is an object of the present invention to provide a liquid crystal display device provided with thin film transistors which can suppress photo leak caused by light emitted from a backlight.

The liquid crystal display device of the present invention aims at the suppression of photo leak by obviating the radiation of light emitted from a backlight to a semiconductor layer of a thin film transistor as much as possible.

The liquid crystal display device according to the present invention may have, for example, the following constitutions.

(1) According to one aspect of the present invention, there is provided a liquid crystal display device which includes: a liquid crystal display panel having a pair of substrates which is arranged to face each other in an opposed manner with liquid crystal sandwiched therebetween; and a backlight arranged on a one-side surface of the liquid crystal display panel, thin film transistors being formed on a liquid-crystal-side surface of the substrate on a backlight side, wherein the thin film transistor is constituted of a gate electrode, a gate insulation film which is formed so as to cover the gate electrode, a semiconductor layer which is formed on an upper surface of the gate insulation film, and a pair of electrodes which is arranged to face each other in an opposed manner on an upper surface of the semiconductor layer from the substrate side as viewed in a plan view, the semiconductor layer is formed of a stacked body consisting of a microcrystalline semiconductor layer and an amorphous semiconductor layer from the substrate side, and the semiconductor layer is formed in an island shape within a region where the gate electrode is formed as viewed in a plan view, and each one of the pair of electrodes is formed such that, as viewed in a plan view, sides of the each one electrode excluding a side of the each one electrode which faces the other electrode project outwardly from the semiconductor layer, and a portion of the each one electrode which projects outwardly from the semiconductor layer overlaps with the gate electrode at least on the periphery of the semiconductor layer.

(2) In the liquid crystal display device having the above-mentioned constitution (1), the semiconductor layer is formed such that a whole region of the microcrystalline semiconductor layer and a whole region of the amorphous semiconductor layer overlap with each other as viewed in a plan view.

(3) In the liquid crystal display device having the above-mentioned constitution (1), the semiconductor layer is formed such that at least a portion of the amorphous semiconductor layer projects from the microcrystalline semiconductor layer as viewed in a plan view.

(4) In the liquid crystal display device having the above-mentioned constitution (1), the semiconductor layer is formed such that at least a portion of the microcrystalline semiconductor layer projects from the amorphous semiconductor layer as viewed in a plan view.

(5) In the liquid crystal display device having the above-mentioned constitution (1), the liquid crystal display panel includes a plurality of pixels, and each pixel is provided with the thin film transistor.

(6) In the liquid crystal display device having the above-mentioned constitution (1), the liquid crystal display panel has a display part which is a mass constituted of a plurality of pixels, a circuit for driving the respective pixels of the display part is formed on the periphery of the display part, and the circuit is provided with the thin film transistor.

(7) In the liquid crystal display device having the above-mentioned constitution (1), the liquid crystal display panel has a display part which is a mass constituted of a plurality of pixels, and drain signal lines which supply a video signal to the pixels, a drive circuit is formed on the periphery of the display part, the drive circuit is a time-division drive circuit which is connected with the plurality of drain signal lines, and supplies the video signal to the plurality of drain signal lines in a sequentially switching manner, and the time-division drive circuit is provided with the thin film transistor.

The above-mentioned constitutions are provided only as one example, and the present invention can be suitably modified without departing from a technical concept of the present invention. Further, the examples of the constitution of the present invention other than the above-mentioned constitutions will become apparent from the description of the whole specification and attached drawings.

According to the liquid crystal display device described above, it is possible to obtain a liquid crystal display device provided with thin film transistors which suppress photo leak caused by light emitted from a backlight.

Other advantages effects of the present invention will become apparent from the description of the whole specification.

### BRIEF DESCRIPTION OF THE DRAWING

FIG. 1 is a constitutional view showing a thin film transistor which is formed on a liquid crystal display device according to an embodiment 1 of the present invention;

FIG. 2 is a plan view showing the liquid crystal display device of the embodiment 1 according to the present invention in an exploded manner;

FIG. 3 is a view showing an equivalent circuit of a display part of the liquid crystal display device according to the present invention;

FIG. 4A and FIG. 4B are views showing the constitution of a pixel in a display part of the liquid crystal display device according to the present invention;

FIG. 5A to FIG. 50 are views showing a liquid crystal display device according to an embodiment 2 of the present invention and are views of a semiconductor layer of a thin film transistor as viewed in a plan view;

FIG. 6A and FIG. 6B are views showing a liquid crystal display device according an embodiment 3 of the present invention and are views showing a state where the liquid crystal display device is provided with a peripheral circuit or a time-division drive circuit;

FIG. 7 is a constitutional view showing an example of a thin film transistor which is formed on a conventional liquid crystal display device; and

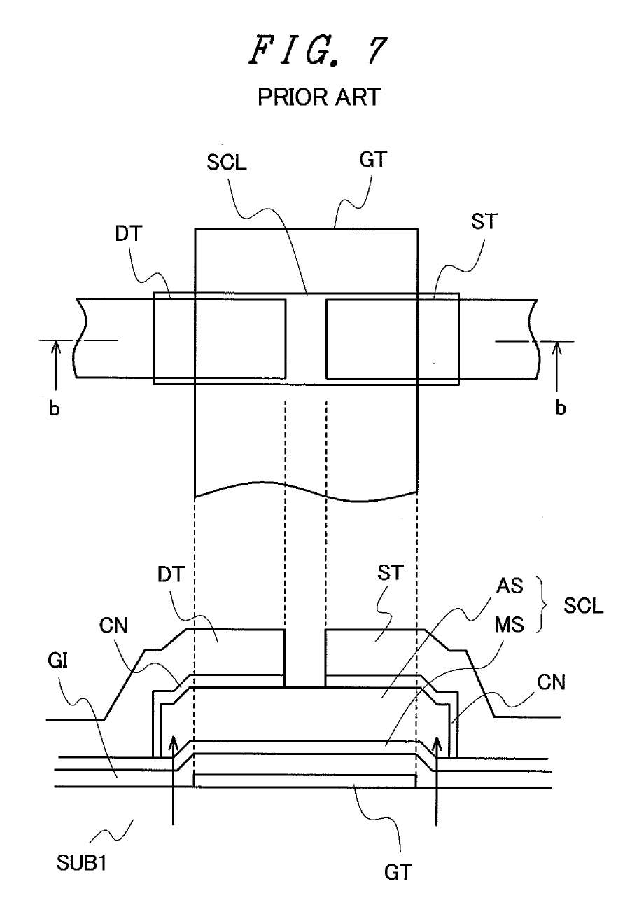

FIG. 8 is a graph showing a phenomenon that a large amount of photo leak occurs in the thin film transistor shown in FIGS. 7A and 7B.

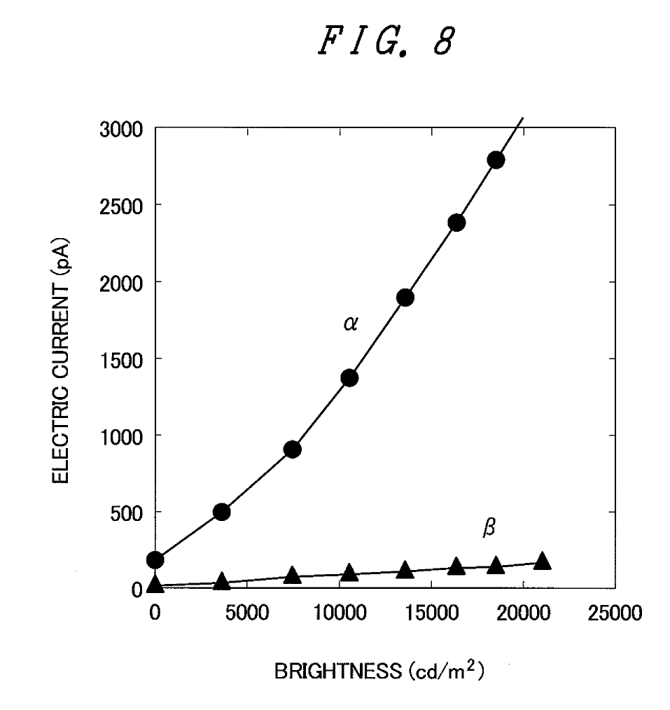

### DESCRIPTION OF THE PREFERRED EMBODIMENT

Embodiments of the present invention are explained in conjunction with drawings hereinafter. Here, in the respective drawings and the respective embodiments, parts having the same or similar constitutions are given same symbols, and their repeated explanation is omitted.

### Embodiment 1

### Schematic Constitution of Liquid Crystal Display Device

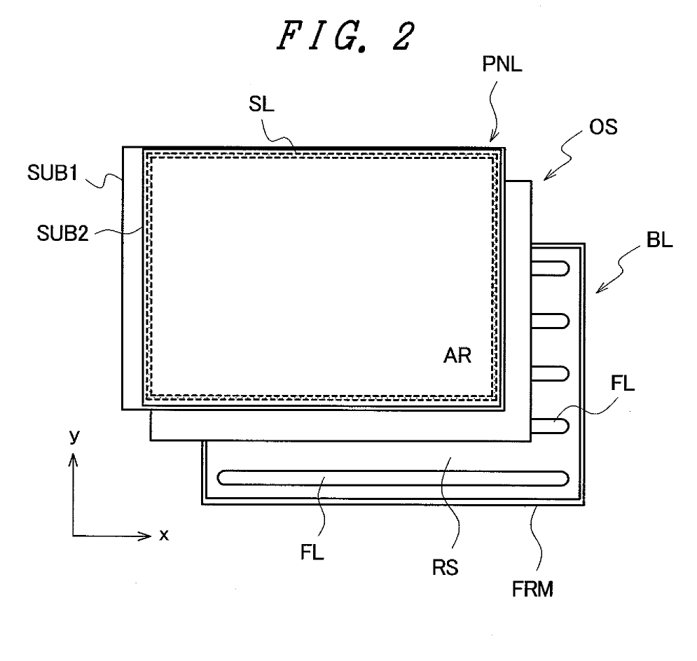

FIG. 2 is a plan view showing a liquid crystal display device of an embodiment 1 according to the present invention in an exploded manner.

The liquid crystal display device is constituted by arranging a liquid crystal display panel PNL, an optical sheet OS, and a backlight BL in this order from a viewer's side (surface side of a paper).

The liquid crystal display panel PNL has an envelope which is constituted of a substrate SUB1 and a substrate SUB2 which are arranged to face each other in an opposed manner with liquid crystal sandwiched therebetween. The substrate SUB1 and the substrate SUB2 are fixedly adhered to each other by an annular sealing material SL which is formed on the peripheries of the respective substrates SUB1 and SUB2. The sealing material SL also has a function of sealing liquid crystal in a space defined by the substrate SUB1, the substrate SUB2 and the sealing material SL. A region which is surrounded by the sealing material SL constitutes a display part AR. Within the display part AR, on liquid-crystal-side surfaces of the substrate SUB1 and the substrate SUB2, a plurality of pixels (not shown in the drawing) each of which adopts liquid crystal LC as one constitutional element thereof are formed in a matrix array. With respect to these pixels, optical transmissivity is controlled independently.

As the optical sheet OS, for example, a prism sheet, a diffusion sheet, or a sheet which is a stacked body consisting of the prism sheet and the diffusion sheet may be used. The optical sheet OS focuses or diffuses light emitted from a backlight BL described later and, thereafter, guides the light toward a liquid crystal display panel PNL side.

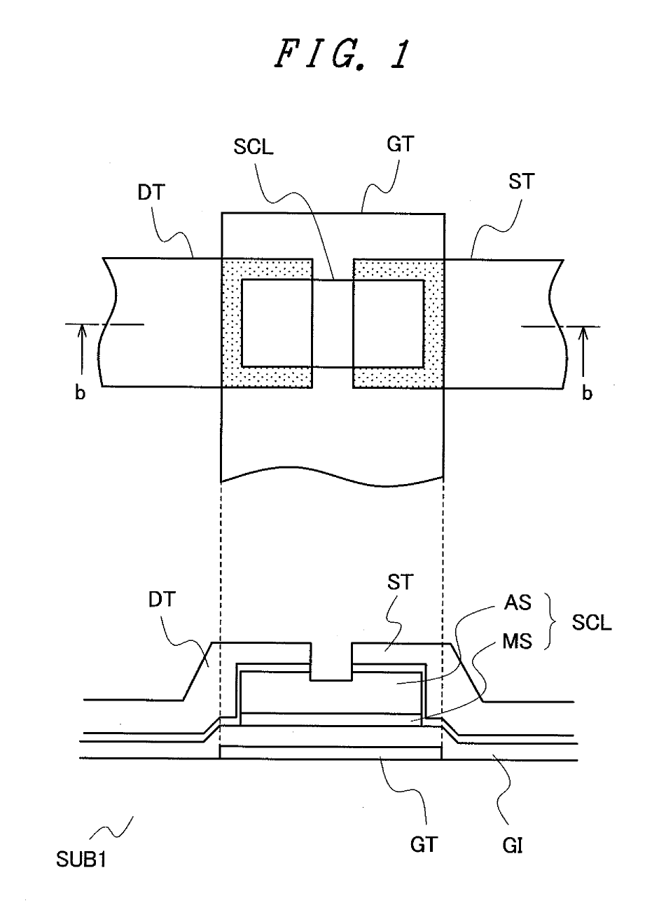

The backlight BL includes a plurality of (five in the drawing, for example) cold cathode fluorescent lamps FL which are arranged parallel to each other in plane parallel to the liquid crystal display panel PNL. The respective cold cathode fluorescent lamps FL have a tube axis thereof aligned with the x direction in the drawing, and are arranged parallel to each other in the y direction at equal intervals in the drawing. The respective cold cathode fluorescent lamps FL are supported on a frame (casing) FRM which is arranged to face the liquid crystal display panel PNL in an opposed manner by way of support members not shown in the drawing. Each cold cathode fluorescent lamp FL emits light upon receiving the supply of electricity from electrodes (not shown in the drawing) formed on both ends thereof. Further, a reflection sheet RS (see FIG. 1B) is arranged on a surface of the frame FRM and below the cold cathode fluorescent lamps FL in the drawing so as to cover the frame FRM. Due to the reflection sheet RS, light emitted from the cold cathode fluorescent lamps FL to a frame FRM side is reflected on the reflection sheet RS and advances toward the liquid crystal display panel PNL.

In this embodiment, the backlight BL has the above-mentioned constitution. However, for example, the liquid crystal display device may use a backlight which is constituted of, at least, a light guide plate which is arranged to face the liquid crystal display panel PNL in an opposed manner, and a light source which is arranged on a side wall surface on one side of the light guide plate.

The above-mentioned liquid crystal display panel PNL, the optical sheet OS, and the backlight BL are, for example, assembled into a module using an upper frame not shown in the drawing, a middle frame not shown in the drawing and the above-mentioned frame FRM (lower frame) thus constituting the liquid crystal display device.

### (Equivalent Circuit of Display Part AR)

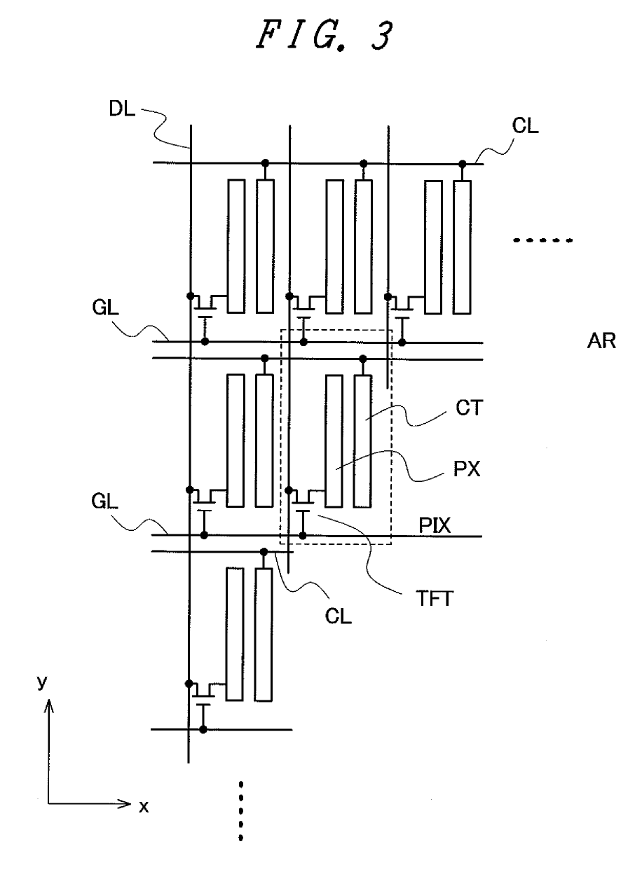

FIG. 3 is a view showing an equivalent circuit of the display part AR. The equivalent circuit shown in FIG. 2 is formed on a liquid-crystal-side surface of the substrate SUB1 of the liquid crystal display panel PNL.

In FIG. 3, gate signal lines GL which extend in the x direction and are arranged parallel to each other in the y direction in the drawing, and drain signal lines DL which extend in the y direction and are arranged parallel to each other in the x direction in the drawing are formed on the substrate SUB1. A region surrounded by a pair of neighboring gate signal lines GL and a pair of neighboring drain signal lines DL constitutes a region of a pixel PIX (within a frame indicated by a dotted line in the drawing), and the display region AR is constituted of a mass of these regions of the pixels.

Each pixel PIX includes a thin film transistor TFT which is turned on in response to a signal (scanning signal) from the gate signal line GL, the pixel electrode PX to which a signal (video signal) from the drain signal line DL is supplied via the thin film transistor TFT in an ON state, and a counter electrode CT which is paired with the pixel electrode PX and to which a reference signal (signal becoming the reference with respect to video signal) is supplied via a common signal line CL. Liquid crystal molecules of this pixel are driven by an electric field corresponding to the potential difference between the pixel electrode PX and the counter electrode CT.

### (Constitution of Pixel PIX)

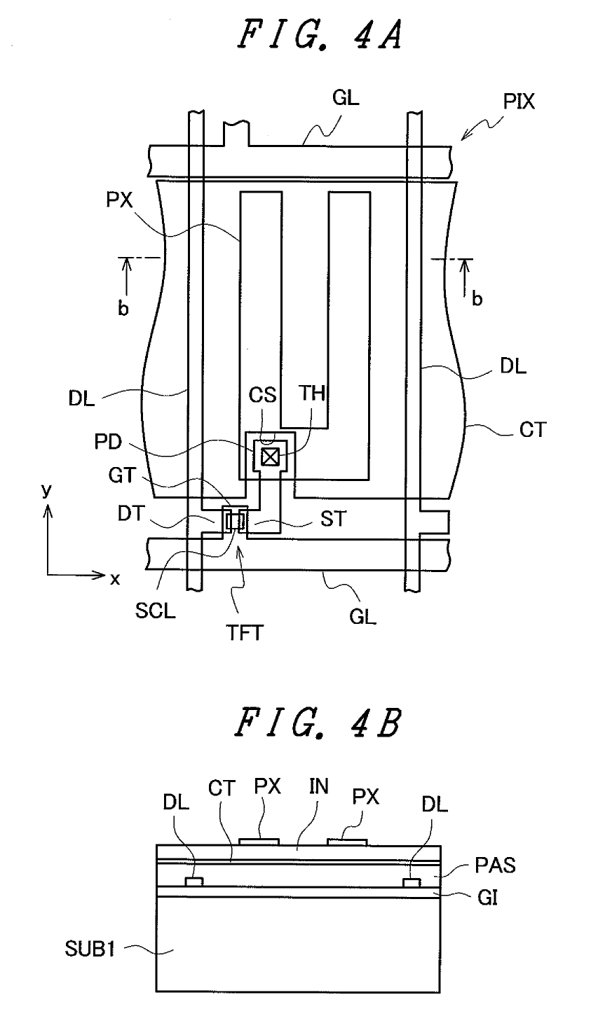

FIG. 4A is a plan view showing the pixel PIX formed on the substrate SUB1. FIG. 4B is a cross-sectional view of the pixel PIX taken along a line b-b in FIG. 4A.

Firstly, as shown in FIG. 4A, the gate signal lines GL which extend in the x direction and are arranged parallel to each other in the y direction in the drawing are formed on a liquid-crystal-side surface of the substrate SUB1. The gate signal line GL includes a projecting portion which extends toward the pixel region side, and the projecting portion functions as a gate electrode GT of the thin film transistor TFT described later. An insulation film GI is formed on a surface of the substrate SUB1 so as to cover the gate signal lines GL. The insulation film GI functions as a gate insulation film of the thin film transistor TFT in a region where the thin film transistor TFT is formed.

On an upper surface of the insulation film GI and within a region which overlaps with the gate electrode GT, a semiconductor layer SCL is formed. The semiconductor layer SCL constitutes a semiconductor layer of the thin film transistor TFT. By forming a drain electrode DT and a source electrode ST on an upper surface of the semiconductor layer SCL such that the drain electrode DT and the source electrode ST are arranged to face each other in an opposed manner, the thin film transistor TFT formed of a bottom-gate-type MIS (Metal Insulator Semiconductor) transistor is formed. Here, the constitution of the thin film transistor TFT is described in detail later.

The drain electrode DT is integrally formed with the drain signal line DL at the time of forming the drain signal lines DL which extend in the y direction and are arranged parallel to each other in the x direction in the drawing. The source electrode ST is formed simultaneously at the time of forming the drain electrode DT. Further, the source electrode ST includes a pad portion PD which extends toward the pixel region and has a relatively large area. The pad portion PD is provided for electrically connecting the source electrode ST and the pixel electrode PX described later with each other.

Here, although the drain electrode DT and the source electrode ST of the thin film transistor TFT is exchangeable depending on a bias application state, in this specification, for facilitating the understanding of the explanation, an electrode which is connected to the drain signal line is referred to as the drain electrode DT, and an electrode which is connected to the pixel electrode PX is referred to as the source electrode ST.

A protective film PAS is formed on an upper surface of the insulation film GI. The protective film PAS is provided for preventing the thin film transistor TFT from coming into direct contact with liquid crystal. For example, the protective film PAS is formed of a sequentially stacked body consisting of an inorganic material film and an organic material film. By selecting a resin film which can be formed by coating as the organic material film, it is possible to form the protective film PAS having a flat surface.

The counter electrode CT which is constituted of a transparent conductive film made of ITO (Indium Tin Oxide), for example, is formed on a surface of the protective film PAS. The counter electrode CT is constituted of a planar electrode which is formed so as to cover the most portion of the pixel region. Further, the counter electrode CT in the pixel region straddles the drain signal line DL and is connected with the counter electrode CT in another pixel region arranged adjacent to the pixel region in the x direction, for example. Due to such a constitution, the common signal lines CL shown in FIG. 3 are also formed of a transparent conductive film.

An interlayer insulation film IN is formed on a surface of the protective film PAS so as to cover the counter electrodes CT, and the pixel electrode PX is formed in the pixel region on a surface of the interlayer insulation film IN. The pixel electrode PX is constituted of a plurality of (two in the drawing) linear electrodes which extend in the y direction and are arranged parallel to each other in the x direction in the drawing, for example. The pixel electrode PX overlaps with the counter electrode CT. The respective linear electrodes of the pixel electrode PX are connected with each other on a thin-film-transistor-TFT side, and a connection portion of the pixel electrode PX where the linear electrodes of the pixel electrode PX are connected with each other is electrically connected to the source electrode ST (pad portion PD) of the thin film transistor TFT via a through hole TH formed in the interlayer insulation film IN and the protective film PAS. In this case, for preventing electrical short-circuiting between the counter electrode CT and the pixel electrode PX, a cutaway portion (or hole) CS is formed in the counter electrode CT in the vicinity of the through hole TH.

An electric field which contains a component parallel to a surface of the substrate SUB1 is generated between the pixel electrode PX and the counter electrode CT, and liquid crystal is driven by such an electric field. The liquid crystal display device having such a constitution is referred to as an IPS (In Plane Switching) liquid crystal display device. However, according to the present invention, the constitution of the pixel is not limited to such IPS-type constitution, and the pixel may adopt other constitutions such as the TN (Twisted Nematic)-type constitution.

### (Constitution of Thin Film Transistor)

FIG. 1A is a plan view showing a portion (within a frame indicated by a dotted line in the drawing) of the thin film transistor TFT shown in FIG. 4A in an enlarged manner. FIG. 1B is a cross-sectional view of the thin film transistor TFT taken along a line b-b in FIG. 1A.

In FIG. 1A and FIG. 1B, the gate electrode GT is formed on an upper surface of the substrate SUB1. The gate electrode GT is made of metal which possesses the favorable conductivity, for example. The insulation film GI is formed on an upper surface of the substrate SUB1 so as to cover the gate electrode GT. The insulation film GI functions as the gate insulation film. A film thickness of the insulation film GI may preferably be set to 300 nm or less (for example, 100 nm), for example.

The semiconductor layer SCL is formed in an island shape on the upper surface of the insulation film GI and within the region where the gate electrode GT is formed as viewed in a plan view. Due to such a constitution, the semiconductor layer SCL overlaps with the gate electrode GT, and the gate electrode GT is formed in a projecting manner from the semiconductor layer SCL on the periphery of the semiconductor layer SCL. Further, the semiconductor layer SCL is formed by sequentially stacking a microcrystalline semiconductor layer MS (for example, made of microcrystalline silicon) and an amorphous semiconductor layer AS (for example, made of amorphous silicon) from a gate electrode GT side. The whole region of the microcrystalline semiconductor layer MS and the whole region of the amorphous semiconductor layer AS overlap with each other as viewed in a plan view. A film thickness of the microcrystalline semiconductor layer MS may preferably be set to 50 nm, for example, and a film thickness of the amorphous semiconductor layer AS may preferably be set to 150 nm to 200 nm.

The drain electrode DT and the source electrode ST which are arranged to face each other in an opposed manner as viewed in a plan view are formed on the upper surface (an upper surface of the amorphous semiconductor AS) of the semiconductor layer SCL. Each of the drain electrode DT and the source electrode ST is formed such that, as viewed in a plan view, sides of one electrode excluding a side of one electrode which faces the other electrode in an opposed manner project outwardly from the semiconductor layer SCL. Further, a portion (a shaded portion in the drawing) of each electrode which projects outwardly from the semiconductor layer SCL overlaps with the gate electrode GT at least on the periphery of the semiconductor layer SCL.

An amorphous semiconductor layer doped with high-concentration impurity (high-impurity-concentration semiconductor layer) is formed below the drain electrode DT and the source electrode ST as a contact layer CN.

Here, the contact layer CN is formed by sequentially forming the high-concentration semiconductor layer and a metal layer for forming the drain electrode DT and the source electrode ST and, thereafter, by sequentially etching the metal layer and the high-concentration semiconductor layer using a photolithography technique one time.

In the thin film transistor TFT having such a constitution, the semiconductor layer SCL is formed in an island shape within the region where the gate electrode GT is formed as viewed in a plan view. Due to such a constitution, light emitted from the backlight BL and radiated to the inside of the liquid crystal display panel after passing through the substrate SUB1 is blocked by the gate electrode GT so that the light is not radiated to the semiconductor layer SCL. Further, the gate electrode GT is formed in an outwardly projecting manner from the semiconductor layer SCL on the periphery of the semiconductor layer SCL as viewed in a plan view and hence, it is possible to prevent the radiation of light to the semiconductor layer SCL caused by the diffraction or wraparound of light from the backlight BL. Accordingly, the radiation of light from the backlight EL to the semiconductor layer SCL can be surely blocked by the gate electrode GT with high reliability.

As described above, when the semiconductor layer SCL is formed of the stacked body consisting of the microcrystalline semiconductor layer MS and the amorphous semiconductor layer AS, due to the radiation of light to the semiconductor layer SCL, photoelectrons and holes which are generated in the amorphous semiconductor layer AS are efficiently separated from each other in the microcrystalline semiconductor layer MS, and a large amount of photo leak occurs. Accordingly, the above-mentioned constitution is extremely effective to cope with such a phenomenon.

Further, each of the drain electrode DT and the source electrode ST is formed such that, as viewed in a plan view, the sides of one electrode excluding the side of one electrode which faces the other electrode in an opposed manner project outwardly from the semiconductor layer SCL. Due to such a constitution, the radiation of light (external light such as sunlight) from the substrate SUB2 side to the semiconductor later SCL can be also blocked by the drain electrode DT and the source electrode ST.

Here, light radiated to the inside of the liquid crystal display panel from the substrate SUB2 side of the thin film transistor TFT is usually blocked by a black matrix (light blocking film) which is formed on a liquid-crystal-side surface of the substrate SUB2. However, to take the radiation of light to the semiconductor layer SCL of the thin film transistor TFT caused by the diffraction or the wraparound of light into consideration, the above-mentioned pattern of the drain electrode DT and the source electrode ST can block the radiation of light caused by the diffraction or wraparound of light with high reliability. This constitution brings about an advantageous effect that it is unnecessary to increase an area of the black matrix for acquiring reliable blocking of the radiation of light to the thin film transistor TFT.

### Embodiment 2

In the thin film transistor TFT of the embodiment 1, the semiconductor layer SCL is configured such that the whole microcrystalline semiconductor layer MS and the whole amorphous semiconductor layer AS overlap with each other.

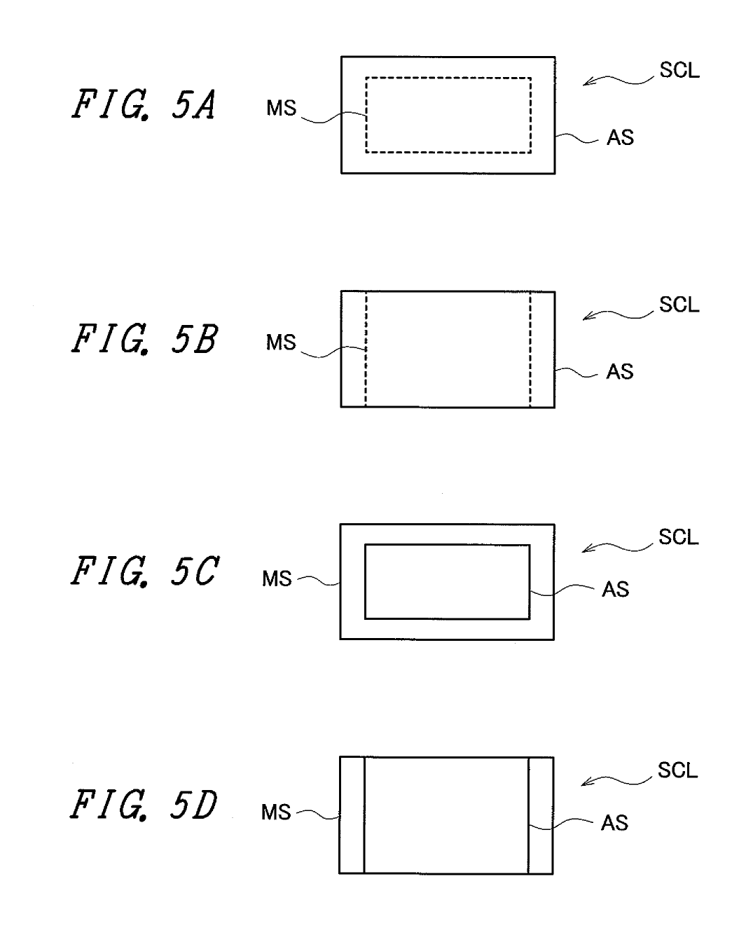

However, as shown in FIG. 5A, the semiconductor layer SCL may be configured such that the amorphous semiconductor layer AS projects from the microcrystalline semiconductor layer MS as viewed in a plan view. Further, as shown in FIG. 5B, a portion of the amorphous semiconductor layer AS may project from the microcrystalline semiconductor layer MS as viewed in a plan view.

Further, as shown in FIG. 5C, the semiconductor layer SCL may be configured such that the microcrystalline semiconductor layer MS projects from the amorphous semiconductor layer AS as viewed in a plan view. Further, as shown in FIG. 5D, a portion of the microcrystalline semiconductor layer MS may project from the amorphous semiconductor layer AS as viewed in a plan view.

Also in the thin film transistor TFT which includes the semiconductor layer SCL having such a constitution, due to the radiation of light, a large amount of photo leak occurs. However, by applying the present invention to the thin film transistor TFT, it is possible largely suppress the occurrence of the photo leak.

### Embodiment 3

With respect to the thin film transistors TFT of the above-mentioned embodiments, the explanation has been made with respect to the thin film transistor which is formed within the respective pixels PIX which constitute the display part AR (pixel selecting switching element).

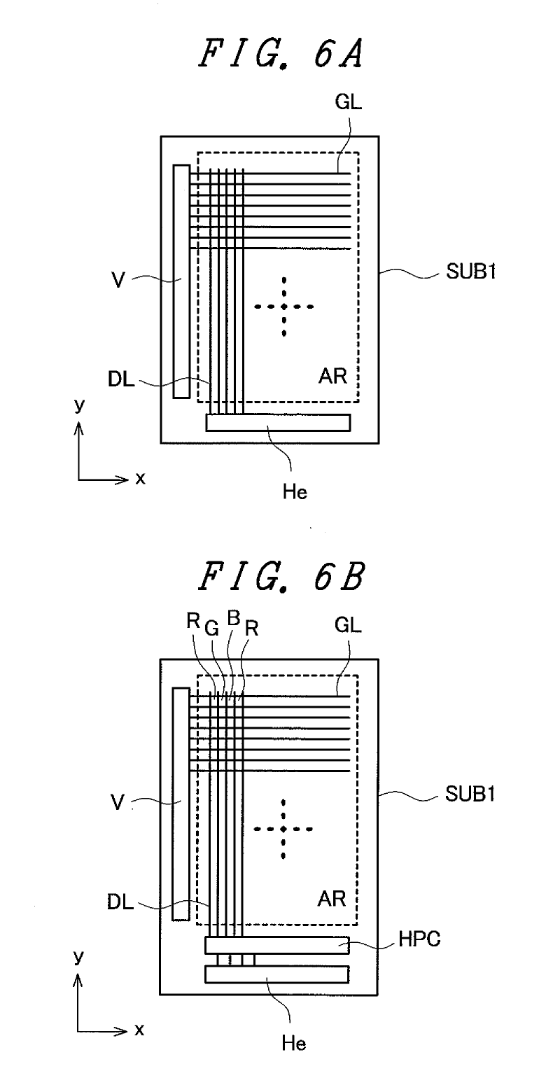

However, there has been known a liquid crystal display device having the constitution shown in FIG. 6A, for example. The liquid crystal display device includes a scanning signal drive circuit V which supplies a scanning signal to respective gate signal lines GL and a video signal drive circuit He which supplies a video signal to respective drain signal lines DL on the periphery of a display part AR of a substrate SUB1. There may be a case where the scanning signal drive circuit V or the video signal drive circuit He may include a thin film transistor which is formed simultaneously with the formation of the thin film transistor TFT formed in each pixel PIX. It is needless to say that, in the liquid crystal display device having such a constitution, the thin film transistor TFT having the constitution explained in conjunction with the embodiment 1 can be used as the thin film transistor formed in the scanning signal drive circuit V or the video signal drive circuit He.

Further, as a color-display-use liquid crystal display device, for example, as shown in FIG. 6B, there has been known a liquid crystal display device in which three pixels which are arranged adjacent to each other (for example, in the x direction in the drawing) and are allocated to respective colors R, G, B constitute a unit pixel for color display, and a RGB time-division drive circuit is arranged between a video signal drive circuit He and respective drain signal lines DL. The RGB time-division drive circuit is configured to sequentially supply video signals to the pixels by switching the video signal for respective pixels allocated to the same color in the respective unit pixels, and the thin film transistor is used as a switching element for performing the switching operation. It is needless to say that the present invention is also applicable to such a thin film transistor.

Although the present invention has been explained in conjunction with the embodiments heretofore, the constitutions explained in the respective embodiments merely show one example, and various modifications of the present invention are conceivable without departing from the technical concept of the present invention. Further, the constitutions explained in conjunction with the respective embodiments may be used in combination unless otherwise the constitutions become contradictory to each other.

What is claimed is:

1. A liquid crystal display device comprising:
a liquid crystal display panel having a pair of substrates which is arranged to face each other in an opposed manner with liquid crystal sandwiched therebetween; and
a backlight arranged on a one-side surface of the liquid crystal display panel,
thin film transistors being formed on a liquid-crystal-side surface of the substrate on a backlight side, wherein
the thin film transistor is constituted of a gate electrode, a gate insulation film which is formed so as to cover the gate electrode, a semiconductor layer which is formed on an upper surface of the gate insulation film, and a pair of electrodes which is arranged to face each other in an opposed manner on an upper surface of the semiconductor layer from the substrate side as viewed in a plan view,
the semiconductor layer is formed of a stacked body consisting of a microcrystalline semiconductor layer and an amorphous semiconductor layer from the substrate side, and the semiconductor layer is formed in an island shape within a region where the gate electrode is formed as viewed in a plan view, and
each one of the pair of electrodes is formed such that, as viewed in a plan view, sides of the each one electrode excluding a side of the each one electrode which faces the other electrode project outwardly from the semiconductor layer, and a portion of the each one electrode which projects outwardly from the semiconductor layer overlaps with the gate electrode at least on the periphery of the semiconductor layer.

2. A liquid crystal display device according to claim 1, wherein the semiconductor layer is formed such that a whole region of the microcrystalline semiconductor layer and a whole region of the amorphous semiconductor layer overlap with each other as viewed in a plan view.

3. A liquid crystal display device according to claim 1, wherein the semiconductor layer is formed such that at least a portion of the amorphous semiconductor layer projects from the microcrystalline semiconductor layer as viewed in a plan view.

4. A liquid crystal display device according to claim 1, wherein the semiconductor layer is formed such that at least a portion of the microcrystalline semiconductor layer projects from the amorphous semiconductor layer as viewed in a plan view.

5. A liquid crystal display device according to claim 1, wherein the liquid crystal display panel includes a plurality of pixels, and each pixel is provided with the thin film transistor.

6. A liquid crystal display device according to claim 1, wherein the liquid crystal display panel has a display part which is a mass constituted of a plurality of pixels,
a circuit for driving the respective pixels of the display part is formed on the periphery of the display part, and
the circuit is provided with the thin film transistor.

7. A liquid crystal display device according to claim 1, wherein the liquid crystal display panel has a display part which is a mass constituted of a plurality of pixels, and drain signal lines which supply a video signal to the pixels,
a drive circuit is formed on the periphery of the display part,
the drive circuit is a time-division drive circuit which is connected with the plurality of drain signal lines, and supplies the video signal to the plurality of drain signal lines in a sequentially switching manner, and
the time-division drive circuit is provided with the thin film transistor.
